(19) United States
(12) Patent Application Publication
(10) Pub. No.: US 2014/0149272 A1
(43) Pub. Date: May 29, 2014

(54) INTEROFFICE BANK OFFERED RATE FINANCIAL PRODUCT AND IMPLEMENTATION

(71) Applicant: trueEX Group LLC, New York, NY (US)

(72) Inventors: Sunil Hirani, Greenwich, CT (US); Alex Francisci, Washington, DC (US)

(73) Assignee: trueEX Group LLC, New York, NY (US)

(21) Appl. No.: 13/970,489

(22) Filed: Aug. 19, 2013

Related U.S. Application Data
(60) Provisional application No. 61/684,493, filed on Aug. 17, 2012.

(51) Int. Cl. G06Q 40/02

(52) U.S. Cl. CPC G06Q 40/025
USPC 705/37; 705/38

(57) ABSTRACT

The present invention is a system, method, and resultant financial for enabling a transparent estimation of an inter-bank offered interest rate which is dependent on market participant's estimations of current lending and borrowing rates. The improved functionality arises through inclusion of both estimated borrowing rates and estimated lending rates to determine a mean inter-bank offered rate. The process implements panel observers, and exception criteria, to preclude determinations biased by skewed estimates provided by panel members and or panel participants. The improved process and system of the present invention further allows implementation of creditworthiness adjustments to inter-bank offered rates based on the creditworthiness of the panel participants, as well as implementation of obligated transactions as a means for dissuading panel members and/or panel participants from submitting biased estimates. The improved mean inter-bank offered rate forms the foundation for financial products whose value is derived from the mean inter-bank offered rate.

### PRIORITY INFORMATION

The present application is a utility application, and claims priority to U.S. provisional application Ser. No. 61/684,493, filed Aug. 17, 2012, titled “Interoffice Bank Offered Rate Financial Product And Implementation,” the content of which is incorporated herein in its entirety by reference thereto.

### BACKGROUND

The London Interbank Offered Rate (LIBOR) is an averaged, estimated interest rate used as a base rate for a variety of financial products. LIBOR is calculated each day at 11:00 AM GMT for fifteen different borrowing periods in ten different currencies. These calculated rates are reported at 11:30 AM every day by Thomson Reuters.

Thomson Reuters calculates the LIBOR daily by polling eighteen global banks and asking them “At what rate could you borrow funds, were you to do so by asking for and then accepting inter-bank offers in a reasonable market size just prior to 11 AM?” The top and bottom quartile of received responses are thrown out and an arithmetic mean of the remaining responses is taken as the LIBOR.

The current system attempts to thwart LIBOR manipulation by omitting the top and bottom quartile of responses. However, the system is not perfect; the current system can be, and is, subject to abuse. One bank could potentially skew LIBOR as described by Edward Murphy in his paper LIBOR: Frequently Asked Questions written for Congressional Research Services:

Recall that the dollar LIBOR panel is made up of 18 banks, with only the responses of the middle 10 being averaged. Suppose that 4 banks report an interest rate of 3%, the next 10 banks report an interest rate of 8%, and 4 banks report an interest rate of 10%. The dollar LIBOR would be calculated by throwing out all of the 3% and 10% responses because the calculation throws out the highest and lowest 4 responses. In this example, the remaining 10 responses are all 8%, so the average would be 80/10=8%. LIBOR would be reported at 8%. However, if a bank that would have reported 10% wants to lower the LIBOR, and the bank lowers its bid from 10% to below 8% (for the sake of this example, assume the response is changed to 2%), the average will change, even though the bank's response is still thrown out. Why? Because one of the 8% responses is now among the highest 4 responses, and one of the 3% responses is in the middle 10. The average is now 75/10=7.5%. In this example, a single bank could move the index from 8% to 7.5%. Murphy, Edward V. “LIBOR: Frequently Asked Questions.” LIBOR: Frequently Asked Questions. Congressional Research Service, 16 Jul. 2012. Web. 9 Aug. 2012. (http://www.fas.org/sgp/crs/misc/R42608.pdf).

This example uses an extreme range of rates, but the point is valid. Given the huge number of financial instruments that are based upon the LIBOR (more than $350 Trillion), a bank that is successful in moving the LIBOR by just 0.0001% could still make huge profits or create huge damages for another bank. Not only is the LIBOR a key benchmark for financial institutions, but the general public bases their car loans, student loans, real estate loans, etc. off of the LIBOR.

As seen in the recently publicized Barclay's LIBOR fixing scandal, one or possibly several banks have already engaged in LIBOR-fixing. Most recently, Barclays and several other banks have been under investigation by the US Securities and Exchange Commission (SEC), the US Department of Justice (DOJ), the UK Financial Services Authority (FSA), the Canadian Competition Bureau (CCB), the Swiss Competition Commission (SCC), and other organizations. Several regulators are currently building criminal cases against traders and banks alike and more fines against banks are likely to come. Though the current LIBOR system is simple, it is fatally flawed, making the need for a new system evident.

The LIBOR is currently calculated by banks submitting a subjective opinion on the rate at which they think that they could borrow money. This approach is unreliable, most notably because of the lack of transparency regarding how banks report rates and the lack of controls to assure the reported rates are realistic estimations.

The key failure points of the current LIBOR system are:
LIBOR is not tradable (it is a subjective opinion)
Manipulative rates are not properly eliminated from the LIBOR calculation
No penalties are issued to banks that submit manipulative rates
No adjustments are made to compensate for the varying credit-worthiness of different banks
LIBOR is calculated by an association, some of whose members are the same banks manipulating LIBOR
The group of banks polled to calculate LIBOR is a closed group

Swaps may be indexed to the LIBOR making them very vulnerable when the LIBOR is manipulated. Currently the process of setting LIBOR is not done by a regulated entity.

### SUMMARY OF THE INVENTION

To ensure that Interoffice Bank Offered Rate indexes are properly governed and indicative of the market, a new approach to calculating a tradable Interoffice Bank Offered Rate is disclosed. This tradable Interoffice Bank Offered Rate is referred to herein as MIBOR.

The following definitions of terms used herein is provided for consistency:

ABR: The arithmetic mean of all non-excluded borrowing rates submitted by governance panel members. Calculated and published daily at 11:30 AM GMT.

ALR: The arithmetic mean of all non-excluded lending rates submitted by governance panel members and participants. Calculated and published daily at 11:30 AM GMT.

Credit Adjustment Table: A table published daily by Exchange Group which would list each member and a rate adjustment for them based upon their credit-worthiness. See FIGS. 12, 13 and 15 for more details.

Governance Panel: A body of shareholders who sign the Exchange Group Governance Panel Agreement and participate is setting MIBOR, as well as setting rules that govern the MIBOR process.

Governance Panel Agreement: A binding agreement among members and participants on the Governance Panel, which in essence states how members and participants agree to submit rates and to stand by those rates in the event that they are asked to trade at that rate.

MIBOR: The arithmetic mean of the calculated ABR and ALR. Calculated and published daily at 11:30 AM GMT.

Panel Participant: Buy-side entities that can lend to panel members and can participate in the MIBOR setting process. See page 5 for more details.

The present disclosure creates a transparent process that may be governed by a panel of members, regulators, and buy-side participants. The process may be managed by an independent and regulated party, whose only incentive in the process is that the MIBOR rate be representative of the true interbank lending rate.

The MIBOR rate may be calculated from both a borrowing rate and a lending rate. Responses gathered to calculate the MIBOR rate may be vetted to remove responses deemed to be attempts at manipulating the MIBOR rate. The system may have enforcement mechanisms embedded within it that will penalize those responders that attempt to manipulate the MIBOR rate, and therefore encourage responders to submit realistic rates.

In one aspect, the present disclosure is directed to a method for decreasing the potential bias of an estimated inter-bank offered interest rate includes identifying panel members to provide estimated interest rates for borrowing and lending. A panel observer serves as a disinterested party regarding analysis of submitted borrowing rate and lending rate estimates. An interest rate analysis platform receives estimated borrowing and lending rates from the panel members. The panel members are provided access to a computer application to allow the panel members to report estimated lending rates and borrowing rates. The method includes receiving at the interest rate platform estimated lending rates and borrowing rates via a computer network, determining on the interest rate platform an average lending rate based on estimated lending rates provided by the plurality of panel members, and determining on the interest rate platform an average borrowing rate based on estimated borrowing rates provided by the plurality of members. The method further includes determining from the average lending rate and the average borrowing rate a mean inter-bank offered interest rate, and disseminating via an electronic network the determined average borrowing rate, the determined average lending rate, and the determined mean inter-bank offered rate to at least one recipient.

In another aspect, the present disclosure is directed to an interest rate swap financial instrument having an obligation to pay to a counter-party a sum of money based on a variable interest rate on a notional amount of the financial instrument and a tenure of the financial instrument. The variable interest rate is determined by a method including identifying panel members to provide estimated interest rates for borrowing and lending, and identifying a panel observer serving as a disinterested party regarding analysis of submitted borrowing rate and lending rate estimates. An interest rate analysis platform receives estimated borrowing and lending rates from the panel members. Panel members are provided access to a computer application to allow the panel members to report estimated lending rates and borrowing rates. The method includes receiving at the interest rate platform estimated lending rates and borrowing rates from the panel members via a computer network, determining on the interest rate platform an average lending rate based on estimated lending rates provided by the plurality of panel members, and determining on the interest rate platform an average borrowing rate based on estimated borrowing rates provided by the plurality of members. The method also includes determining from the average lending rate and the average borrowing rate a mean inter-bank offered interest rate.

In yet another aspect, the present disclosure is directed to a system for determining a mean inter-bank offered rate that includes an interest rate platform communicably connected to at least one computer network. A plurality of panel members report estimated lending rates and estimated borrowing rates to the interest rate platform through the computer network. At least one panel observer observes determinations of average lending rates, average borrowing rates, and a mean inter-bank offered rate, and identifies potentially biased estimated borrowing rates and lending rates reported by the panel members. The interest rate platform receives estimated lending rates and estimated borrowing rates from the panel members, applies exception criteria to the reported estimated lending rates and the estimated borrowing rates, and determines an average lending rate, and average borrowing rate, and a mean inter-bank offered rate from the estimated lending rates and estimated borrowing rates.

### BRIEF DESCRIPTION OF THE FIGURES

FIG. 1 is a schematic diagram that illustrates a notional system for implementing calculation of MIBOR values.

FIG. 2 is a schematic diagram that illustrates various features of the present invention.

FIG. 3 is a graph of rate versus banks that illustrates a trend line on LIBOR reported rates.

FIG. 4 is a graph of rate versus banks that illustrates line T, which represents where banks think they can borrow.

FIG. 5 is a graph that illustrates an active manipulation removal system for lower data bounds and a passive system for upper data bounds, wherein L represents a set of lending rates received and B represents a set of borrowing rates received.

FIG. 6 is a graph of rate versus banks that illustrates non-crossing lending and borrowing response distribution.

FIG. 7 is a graph of rate versus banks that illustrates touching lending and borrowing response distribution.

FIG. 8 is a graph of rate versus banks that illustrates crossing lending and borrowing response distribution.

FIG. 9 is a graph of rate versus banks that illustrates non-crossing lending and borrowing response distribution with a single bank trying to fix rate.

FIG. 10 is a graph of rate versus banks that illustrates non-crossing lending and borrowing response distribution with worst 50% highlighted.

FIG. 11 illustrates a notional sample Credit Adjustment Table as submitted by one panel member.

FIG. 12 is a graph of scaling factor versus years that illustrates an exemplary adjustment curve.

FIG. 13 illustrates an exemplary adjustment table based upon the adjustment curve in FIG. 12.

FIG. 14 illustrates an exemplary list of possible MIBOR values for a broader MIBOR implementation

FIG. 15 is a schematic diagram that illustrates three panel members and one panel participant with credit adjustments for other panel members shown.

FIG. 16 illustrates pseudo computer code of one embodiment of the present invention.

FIG. 17 illustrates a flow diagram of one embodiment of the present invention.

### DETAILED DESCRIPTION OF THE INVENTION

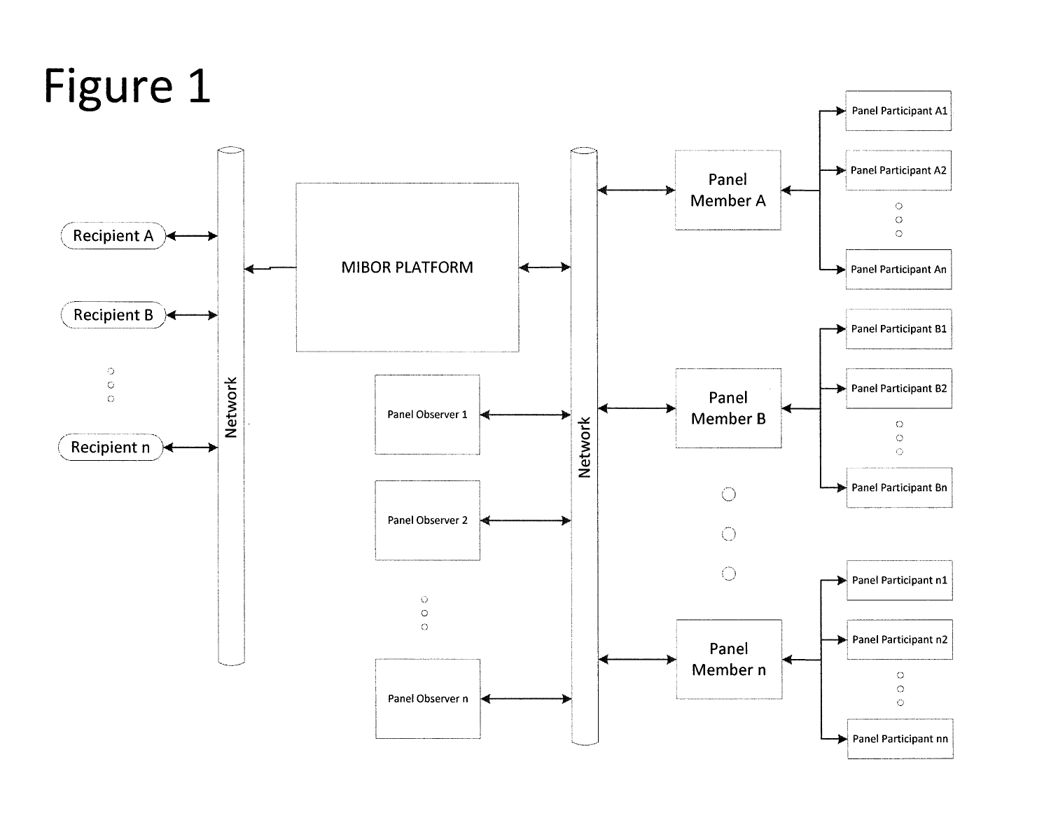

The present disclosure is based on the creation of a data acquisition, aggregation, regulation, and dissemination system in which multiple sources are utilized to determine expected borrowing and lending rates as perceived by market participants, condition the data to preclude manipulation of the expected inter-bank lending rates, and disseminate the resultant product to users. As shown in FIG. 1, the present disclosure may be implemented in a system in which a governing panel structure is used to implement the invention. The governance panel structure may include a computer platform (the interest rate Platform or “MIBOR platform”) for managing information flow, as well as performing analysis and conditioning on received data, and dissemination of calculated values.

The members of the governance panel (apart from the MIBOR platform itself) may be comprised of an unlimited number of stakeholders within each of three classes: panel members, panel observers, and panel participants, for example.

Panel members may be major financial institutions which clear interest rate swaps, such as for example central counterparty clearing houses. The function of the Panel members is to both identify participants in the market, but also to be able to vette the suitability of panel participants to be involved in the MIBOR aggregation process. Major financial institutions that clear interest rate swaps through the Chicago Mercantile Exchange (CME) or the London Clearing House (LCH) may be suitable Panel members.

The function of the panel observer is to provide transparency to the process, such as to ensure that no manipulation of a calculated MIBOR rate occurs. The panel observers may be responsible for defining criteria on which data may be included or excluded in an aggregation, as well as identification of proactive procedures under which efforts to manipulate a MIBOR aggregation through the use of skewed interest rate estimates may be dissuaded. Preferable panel observers may include major regulatory entities, particularly within the swaps markets, which have an interest in observing the process and in providing guidance to the panel. Major regulatory bodies, particularly of the swap market, such as the United States Commodities Futures Trading Commission (CFTC), the United States Federal Reserve (Fed), the Bank of England (BoE), the European Central Bank (ECB), and the Financial Services Authority (FSA) may be asked to be and serve as panel observers. Panel observers could be able to access meetings and meeting minutes, with the goal of making the process more transparent.

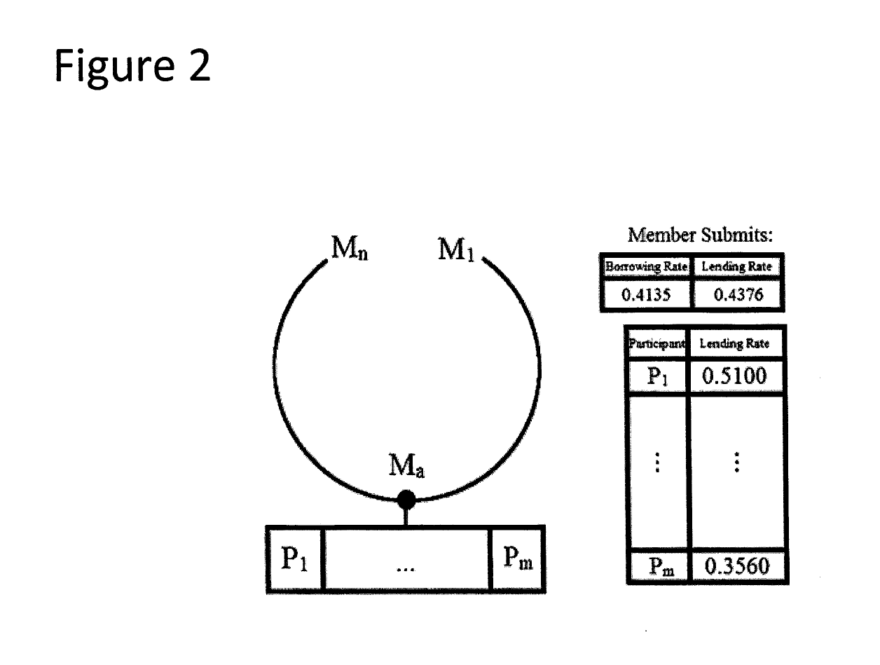

While the present system and process may be implemented without inclusion of panel participants, the inclusion of panel participants may allow for a more robust data set on which MIBOR aggregation can occur. Buy-side entities that wish to participate in the process would be able to do so by becoming a panel participant. As shown in FIG. 2, panel participants (P₁-Pₘ) would be able to submit a lending rate to a panel member (M₁-Mₙ) for the panel member to then submit to the MIBOR process. Panel participants must be sponsored by a panel member through whom the panel participant would submit their lending rate. The panel member would be able to guarantee that the panel participant has the required funds should a different panel member wish to borrow from the panel participant. Panel participants would not be allowed to submit borrowing rates because it would require that Lenders be able to determine the credit-worthiness of the panel participant. The panel participant role would open the process to a broader group of constituents.

As shown FIG. 2, each panel member can have one or more panel participants associated with that panel member. The panel member guarantees that each panel participant associated with the panel member has the capital to be lending. FIG. 2 also illustrates a data set for a panel member, which would preferably include estimated borrowing rate and estimated lending rate information from the panel member, as well as estimated lending rates from each panel participant associated with that panel member.

The MIBOR Platform would be responsible for receiving the submitted borrowing and lending rate responses and for calculating three fixing rates:

1) Average Borrowing Rate: (hereafter “ABR”) An average of the reported borrowing rates after excluding manipulative responses.

2) Average Lending Rate: (hereafter “ALR”) An average of the reported lending rates after excluding manipulative responses.

3) MIBOR Rate: An average of the ABR and ALR. MIBOR is designed to replace the current LIBOR.

A notable aspect of the present disclosure lies in the method in which data used to aggregate the MIBOR rate is acquired and conditioned. The basic data from which the MIBOR rate may be calculated consists of responses from panel members (and panel participants, if panel participants are included in the process). For an illustrative calculation, based on a three month loan term, and a notional value of $100 million USD, these questions may preferably be:

1) At what rate would you be willing to borrow $100 million USD for a 3 month term from any other panel member just prior to 11 AM?

2) At what rate would you be willing to lend $100 million USD for a 3 month term to the most credit-worthy panel member just prior to 11 AM?

3) If lending at the MIBOR, what additional rate would you ask of each individual panel member to compensate for your estimation of their credit worthiness?

4) What is your estimation of the rate that other panel members would ask for, in addition to the MIBOR, to compensate for your credit worthiness?

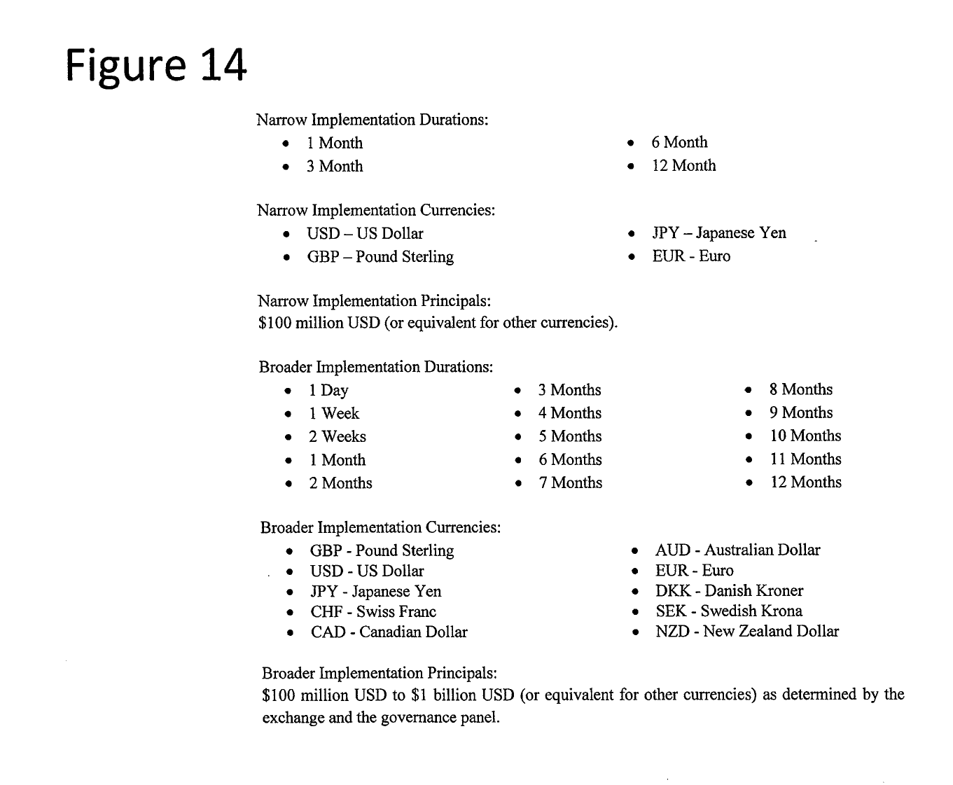

As noted, these questions are illustrative questions for a 3 month loan on a principal of $100 million USD. In a broader context, these questions may be asked of panel members for US Dollars, Pound Sterling, Japanese Yen, and the Euro for terms of 1 month, 3 months, 6 months, and 12 months on a principal of $100 million USD (or equivalent). In a broader embodiment, these questions could be asked of panel members for fifteen different durations in ten currencies on a principal of $100 million to $1 billion (see FIG. 14). The principal amount could be decided based upon market conditions and with feedback from the panel observers. These questions assume that the panel members are large enough that borrowing or lending $100 million to $1 billion is feasible for them.

The panel observers could be responsible for setting a maximum spread variable, a tolerance variable, and an exclusion variable, as discussed further below. The exchange could propose values for each of these variables and the panel members then vote on the proposed values. Each panel member could be allowed one vote and a two-thirds majority of votes for the proposed value could be necessary to set each variable. The exchange could have veto power in any vote to set a value for any variable. In the event that the panel members were unable to agree on a value for a variable after a reasonable number of attempts, the panel observer(s) could unilaterally set the value of the variable in question.

The Maximum Spread Variable could be the maximum difference allowed between a panel member's submitted lending and borrowing rates, and could be set by the panel observers, as discussed further below. The Tolerance Variable may be a variable that is set by the panel observers that describes the maximum allowable borrowing-lending crossing amount, as discussed further below. The Exclusion Variable could be a percent of borrowing and lending rate responses which are excluded from MIBOR calculations. The exclusion variable may be set by the panel observers, as discussed further below

The approach of asking the above questions can make the process more objective in two important ways. First, these questions eliminate variations resulting from different banks varying interpretations of “offers in a reasonable market size” which might otherwise affect the raw data used for calculation of the ABR, MIBOR, and ALR. Second, by asking for both a borrowing and a lending rate, the data would reveal irregularities in reported rates or attempts to bias the ABR, MIBOR, or ALR. This second point is discussed further below with respect to the preventative mechanisms of the system which will allow data that has been manipulated to be eliminated, leaving only the remaining data to be used as a basis for determining the MIBOR rate.

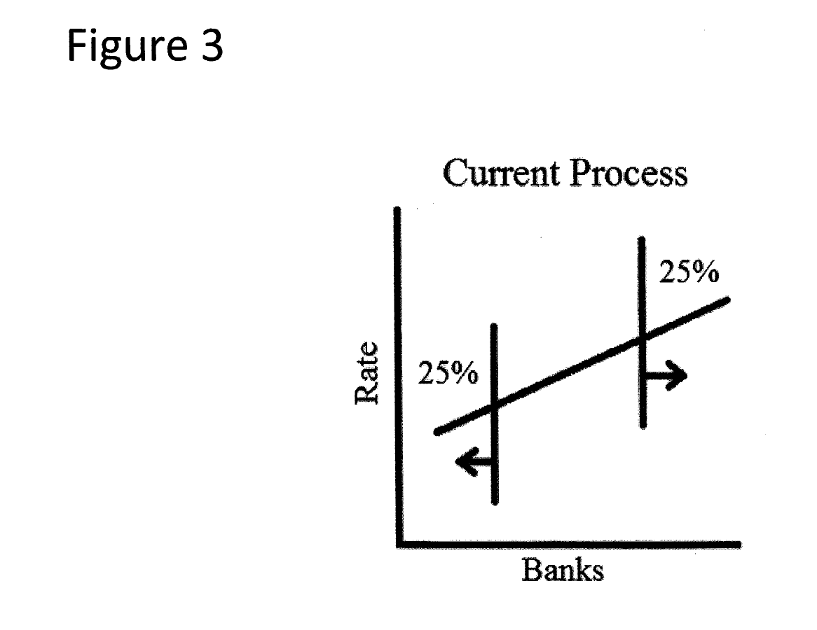

The current system for calculating LIBOR uses only a single set of data and uses a passive manipulation preventative method, as illustrated in FIG. 3, which is a representative figure of a trend line on LIBOR reported rates (organized from smallest to largest). Everything in the direction of the arrows is thrown out using passive lower bounds and passive upper bounds. Thus, the highest 25% of data received and the lowest 25% of data received is discarded.

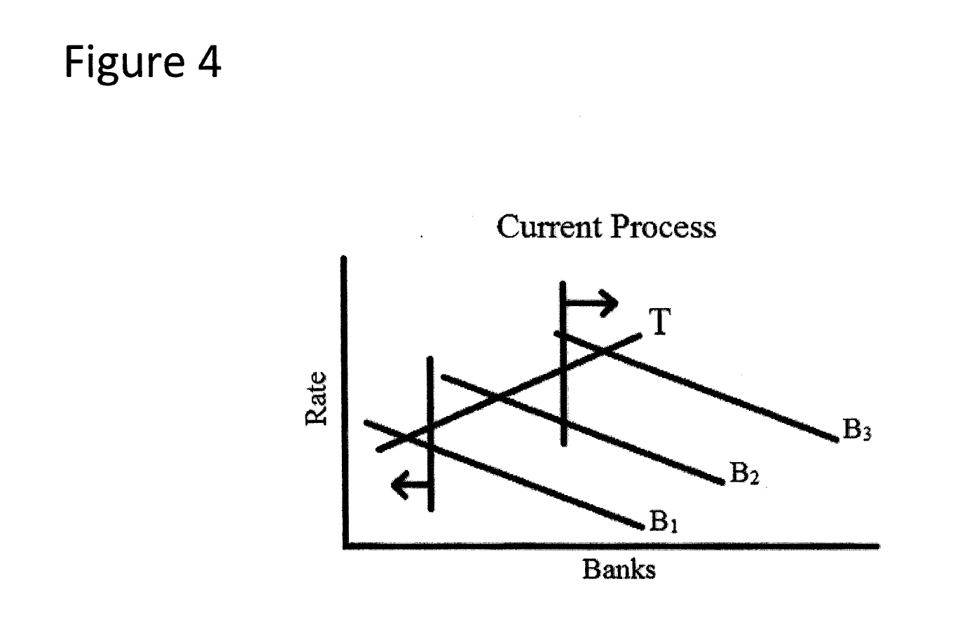

Furthermore, absent manipulation, the single set of data used in estimating LIBOR is not enough to know where lenders and borrowers will actually trade. As illustrated in FIG. 4, the line T represents where banks think they can borrow. The lines B1, B2, and B3 represent possible borrowing curves. A borrowing curve could cross T anywhere, including in the top or bottom 25% of responses. Without calculating a borrowing curve, it is impossible to tell if LIBOR is indicative of the actual offer rate or not. Because no borrowing curve is currently calculated, the borrowing curve could cross where banks think they can borrow in either the upper 25% or lower 25% of responses. But since those responses will be thrown out, the calculated LIBOR rate will not truly be indicative of where borrowing will actually happen. Where banks think they could borrow becomes the lending rate, regardless of whether that rate is a good estimation or not.

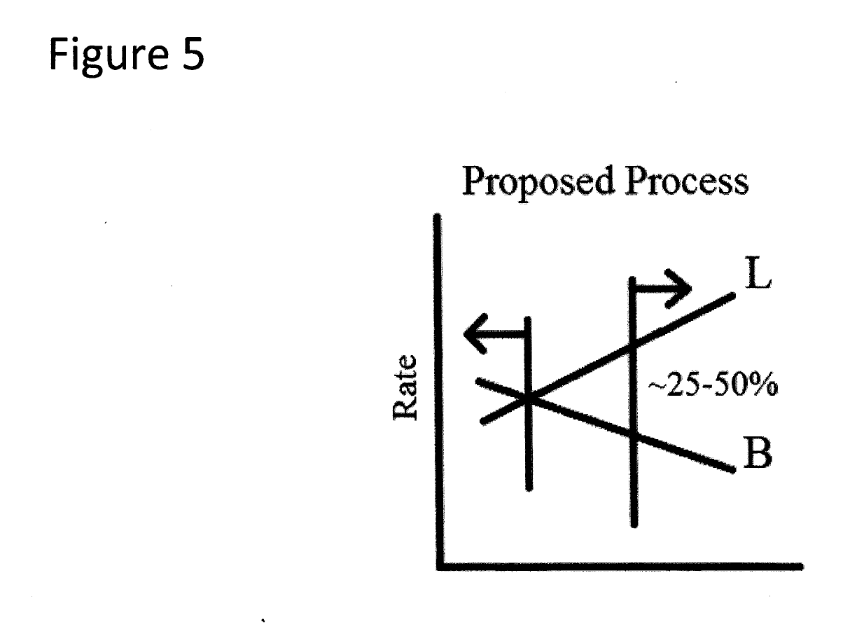

The present disclosure for calculating the ABR, MIBOR, and ALR rates uses an active manipulation removal system for the lower data bounds and a passive system for the upper data bounds, as illustrated in FIG. 5. The active bounds (left arrow in FIG. 5) will eliminate all rates which are below a set tolerance level, discussed further below. The passive bounds (right arrow in FIG. 5) will eliminate all rates which are above a set exclusion rate, discussed further below. The present method also makes use of the two sets of data to determine the true mid-point of the actual market lending rate. In FIG. 5, L represents the set of lending rates received and B represents the set of borrowing rates received.

As a further feature to limit the amount that a panel member could manipulate the ABR, MIBOR, and ALR, the governance panel may impose, and the panel observers may vote on, a maximum spread value. For instance, if the maximum spread was set to 0.25% then a panel member could not submit a borrowing rate and a lending rate greater than 0.25% apart. For example, one panel member's submission of a borrowing rate of 0.2550 and a lending rate of 0.5050 would be acceptable but a borrowing rate of 0.4300 and a lending rate of 0.6890 would not be acceptable. Borrowing and lending rates submitted by a panel member that are more than the maximum spread apart would be eliminated and not used as part of the ABR, MIBOR, and ALR calculations. Initially, the maximum spread could be set at 0.25%.

The present method provides further benefit in that both sides of the market (borrowing and lending) are captured which gives a much more accurate picture of the rate at which members would actually lend and borrow money.

There are two areas that the present process focuses on when looking for data that attempts to manipulate the ABR, MIBOR, or ALR rates. As can be seen in FIG. 5, there could be manipulative data to the left of where the borrowing and lending rate curves cross, or there could be manipulative data to the far right of the lending and borrowing curve. In the first case, a panel member might respond with an unreasonably high borrowing rate or an unreasonably low lending rate. In the second case, a panel member might try to respond with an unreasonably low borrowing rate or an unreasonably high lending rate.

A panel member might attempt to manipulate the ABR, MIBOR, and ALR rates by responding with a high borrowing rate or a low lending rate. In order to illustrate these potentials, graphs containing two complete data sets received through polling eighteen (18) panel members using the questions posed above may be used to illustrate the scenarios. For this illustration, it is assumed that there are no additional lending rates submitted by participants. Three scenarios could arise from graphing this data:

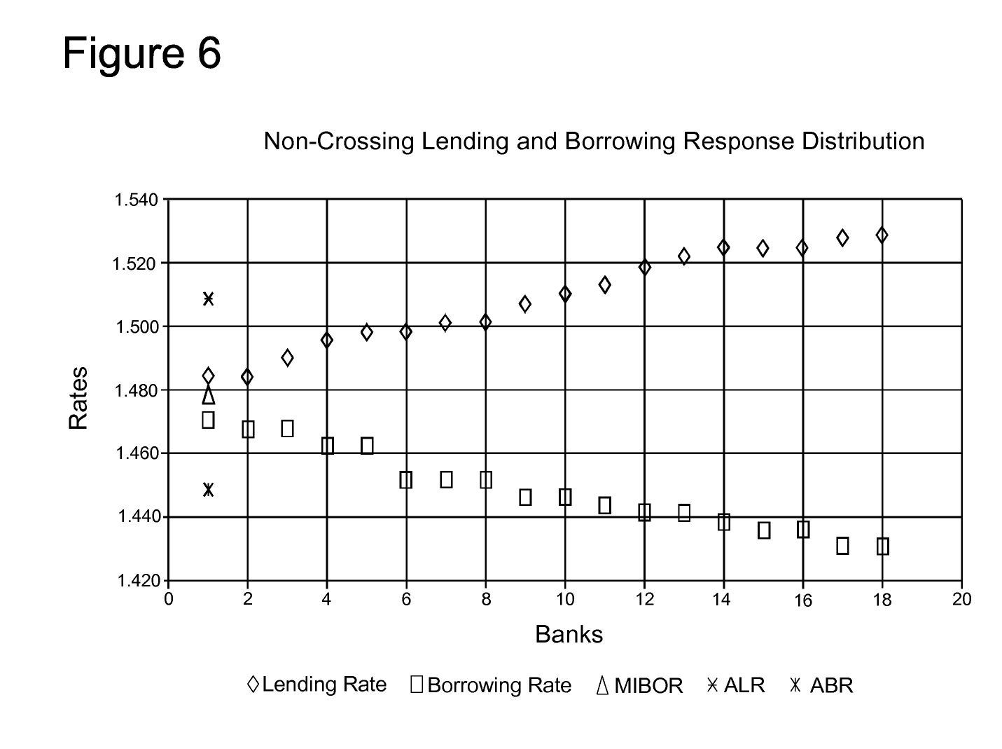

1) All of the borrowing rates are less than the lowest lending rate. Alternatively, all lending rates are higher than the highest borrowing rate, as shown in FIG. 6;

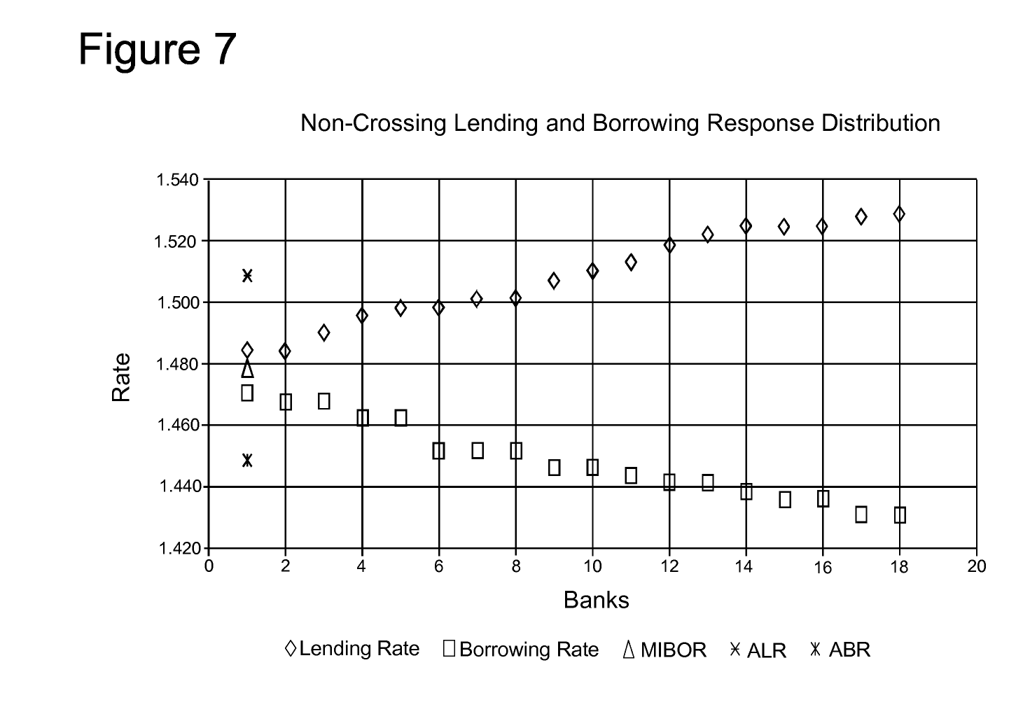

2) One or several borrowing rates are equal to one or several lending rates, as shown in FIG. 7; or

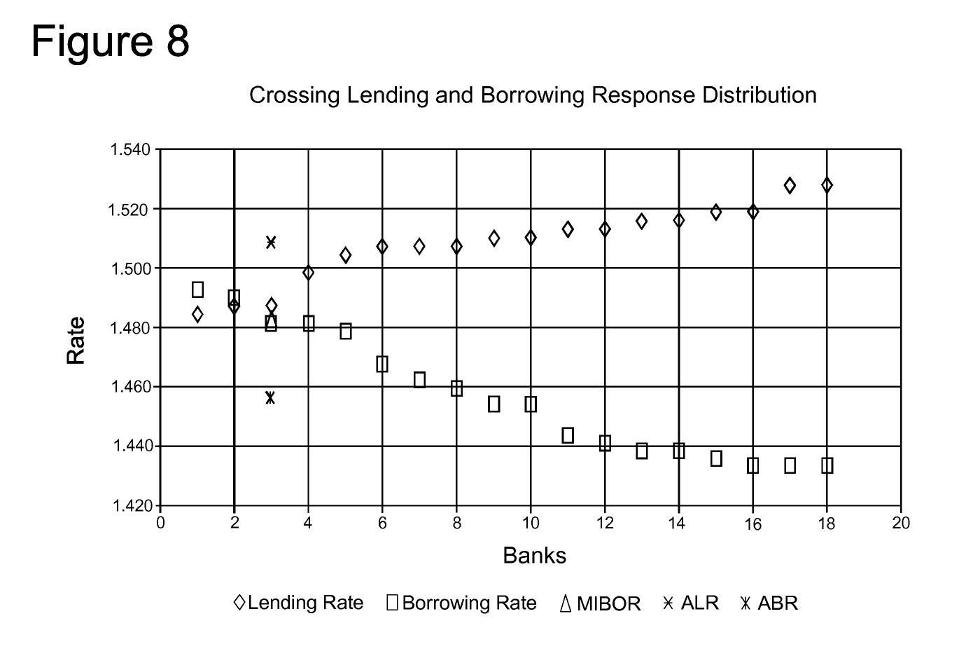

3) One or several borrowing rates are greater than one or several of the lowest lending rates. Alternatively, one or several lending rates are less than one or several of the highest borrowing rates, as shown in FIG. 8.

FIG. 6 illustrates Case 1 in which all estimated borrowing rates are less than the lowest estimated lending rate. In the illustration, a borrowing rate and lending rate on the same number (i.e. 4 or 14) does not indicate that both of those numbers came from the same panel member, but rather that those two rates have simply been paired up after sorting the data. For the purposes of the illustration, the data was randomly generated.

FIG. 7 illustrates Case 2 in which one borrowing rate equals one lending rate but the ABR, MIBOR, and ALR are calculated the same way. Again, for the purposes of the illustration, the data was randomly generated.

FIG. 8 illustrates Case 3 in which two borrowing rates are higher than the lowest lending rate and two lending rates are lower than the highest borrowing rate. Again, for the purposes of the illustration, the data was randomly generated.

Note that because it would be illogical for any panel member to offer to lend at a rate lower than it would expect to borrow, it is implausible for all of the lending rates to be less than all of the borrowing rates.

Furthermore, the MIBOR Platform for collecting member's data could prevent a member from submitting a borrowing rate that is higher than its lending rate or a borrowing rate and a lending rate that are farther apart than the maximum spread.

In Cases 1 and 2 (FIG. 7 and FIG. 8), assuming that no member is trying to manipulate the MIBOR process, these two sets of data would provide the exchange with a valid basis for determining the ABR, MIBOR, and ALR rates. The exchange would take the arithmetic mean of the non-excluded borrowing rates to calculate the ABR, the arithmetic mean of the non-excluded lending rates to calculate the ALR, and the arithmetic mean of the ALR and the ABR to calculate the MIBOR rate.

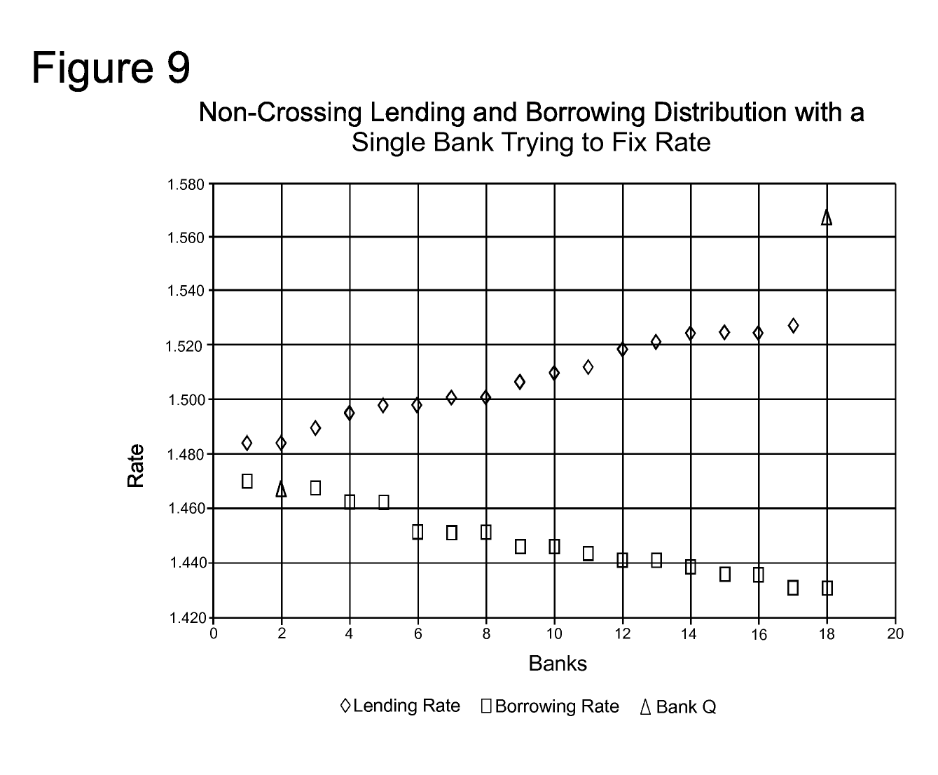

Case 3 is a special case because lending rates that are lower than borrowing rates or vice versa (outside of a certain tolerance range) are possible attempts to fix the ABR, MIBOR, or ALR rates. It is unreasonable for a panel member to offer a lending rate that is much lower than the best borrowing rate or a borrowing rate that is much higher than the best lending rate unless the member is trying to fix the ABR, MIBOR, or ALR rates. In FIG. 9, which illustrates non-crossing rates with Bank Q (shown as the triangular data points), when attempting to raise the MIBOR and ABR rates (data was randomly generated), the borrowing and lending rate data points at 1 and 2 would be eliminated.

An analogous situation would be if an auctioneer is selling a normal $100 bill but receives an offer to buy it for $150 or, similarly, if the auctioneer was willing to sell the bill for $50. In the first case, the buyer appears to have something to gain above and beyond the value of the bill by buying it and, in the latter case, the auctioneer appears to have something to gain above and beyond the value of the bill by selling it. But in the absence of a logical explanation, the transaction is suspect.

Because such data misrepresents the ABR, MIBOR, and ALR rates, it is eliminated from calculations. However, the panel may propose, and the governance panel could vote on, a tolerance variable. For instance, if the tolerance is set to 0.001%, a borrowing rate that crosses a lending rate by 0.001% or less, or vice versa, would be assumed to be a valid data point. Initially, the tolerance level would preferably be set to 0.

After eliminating those points that are outside of the tolerance range, the exchange would take the arithmetic mean of the remaining borrowing rates to get the ALR rate and the arithmetic mean of the remaining lending rates to get the ABR rate. The MIBOR rate could be calculated from the average of the ABR and ALR rates.

A panel member might also attempt to manipulate the ABR, MIBOR, and ALR rates by responding with an unreasonably high lending rate or an unreasonably low borrowing rate. This type of manipulation has a more obvious effect; for example, a particularly high lending rate would pull the ABR and MIBOR rates up, and a particularly low borrowing rate would pull the MIBOR and ALR rates down.

If a panel member was attempting to manipulate the ABR, MIBOR, or ALR rates without reporting a borrowing rate that crosses the best lending rate or a lending rate that crosses the best borrowing rate, by reporting a close to mid-point borrowing rate and a high lending rate, a panel member might attempt to raise the ABR and MIBOR rates (see FIG. 8). Similarly, a panel member could report a low borrowing rate and a close to mid-point lending rate in an attempt to lower the MIBOR and ALR rates.

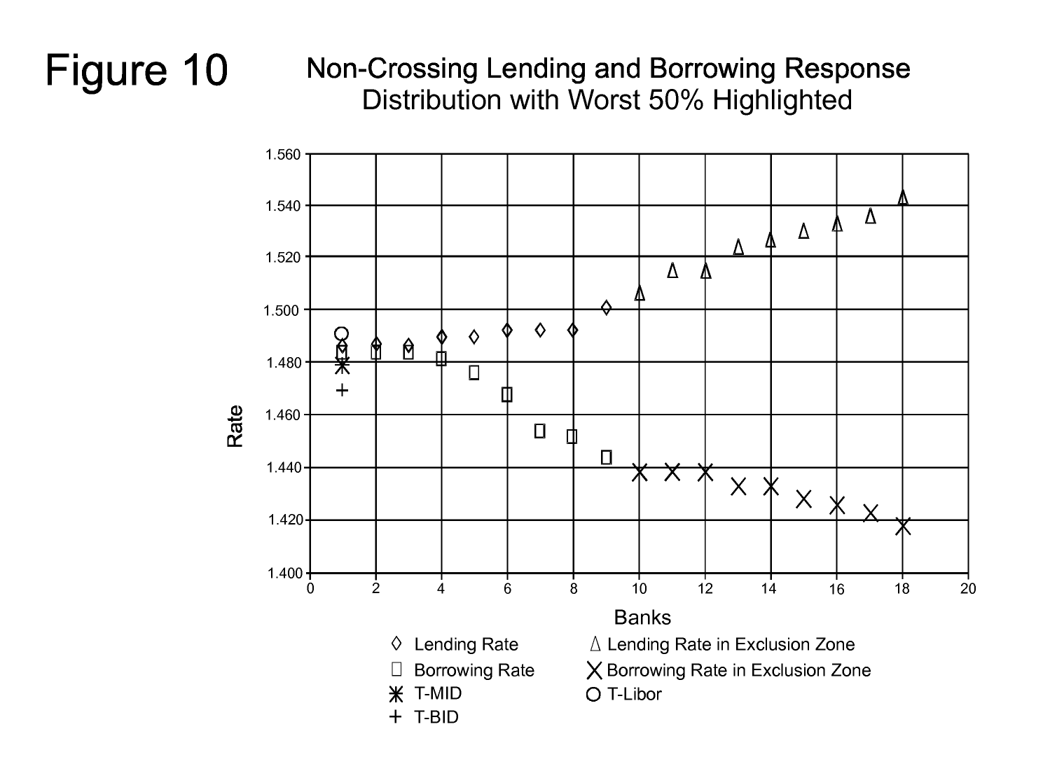

To remove reported rates that are potentially harmful, the exchange could propose, and the governance panel could vote on, an exclusion variable. The exclusion variable could be a percent of the highest reported lending rates and the lowest reported borrowing rates to be excluded in the final calculation of the MIBOR, as shown in FIG. 10, illustrating non-crossing rates assuming an exclusion variable set at 50%. The rates in the exclusion zone would not be used in the calculation of the ABR, MIBOR, or ALR. For instance, an exclusion variable of ½ (or 50%) would exclude the highest 50% of lending rates and the lowest 50% of borrowing rates. The exclusion variable could be applied after excluding rates outside of the tolerance range. The exclusion variable would initially be set at ½ (50%). This measure should effectively limit manipulation of the MIBOR rate by one or even a small number of panel members.

Defining Valid Responses

For the purposes of discussion, let there be two sets of data, BF and LF, which will contain all reported borrowing rates and all reported lending rates, respectively. These two sets will be narrowed down and then used to calculate the ABR, MIBOR, and ALR rates.

Let the Borrowing Rate responses be modeled by the set B_{O} where each element of set B_{O} (b_{O}1, b_{O}2, etc.) is a response by a panel member to the question: At what rate would you be willing to borrow $100 million USD for a 3 month term from any other panel member just prior to 11 AM? Furthermore, let set BO be sorted from largest to smallest:

B_{O}={b_{O}1,b_{O}2, . . . , b_{O}n} (1)

Let the lending rate responses be represented by the set L_{O} where each element of set L_{O} (l_{O1}, l_{O2}, etc.) is a response by a panel member or panel participant to the question: At what rate would you be willing to lend $100 million USD for a 3 month term to any other panel member just prior to 11 AM? Furthermore, let set L_{O} be sorted from smallest to largest:

L_{O}={l_{O1},l_{O2}, . . . ,l_{Om}} (2)

Let the exclusion variable be described by “x” which is a variable in the exclusion function E(x):

$$E ( x ) = \frac{1}{x} , 1 < x \qquad ( 3 )$$

The exclusion function (4) may be applied to a set such that:

V={v₁,v₂, . . . ,v^{q}}

V(E(x))={v_(n/x),v_(n/x+1), . . . ,v_{—}n} (4)

Let the tolerance variable be described by “y” which is a variable in the tolerance function T(y):

T(y)=y,0≦y≦0.010 (5)

Let there be two more sets, B_{Z} and L_{Z}, which can be described as the borrowing exclusion set and the lending exclusion set respectively. These sets are initially empty, but elements will be added to them as certain borrowing or lending responses are found to be data that must be excluded from ABR, MIBOR, and ALR calculations:

B_{Z}={Ø} (6)

L_{Z}={Ø} (7)

First, all lending rates that cross the corresponding bid outside of the tolerance range (5) may be added to sets B_{Z} and L_{Z} as they are defined in steps 6 and 7:

bᵢ−lᵢ>T(y)→bᵢεB_{Z}&&lᵢεL_{Z},0<i<|B_{O}| (8)

Then, the exclusion function (3) may be applied to the set of borrowing rates (1) and the set of lending rates (2). These excluded rates could be added to the exclusion sets as defined after steps 8 and 9. This exclusion is designed to remove low borrowing rates or high lending rates that attempt to manipulate the final value of the ABR, MIBOR, and ALR rates:

∀bᵢ(bᵢεB_{O}(E(x))→bᵢεB_{z}) (9)

∀lᵢ(lᵢεL_{O}(E(x))→lᵢεL_{Z}) (10)

Finally, the final data sets B_{F} and L_{F} may be derived by removing all elements in the exclusion sets, as defined after steps 9 and 10, from the borrowing and lending sets (1 and 2) that are common between the two leaving just the rates that are most likely to be free of tampering:

B_{F}=B_{O}−B_{Z}={b_{f1},b_{f2}, . . . ,b_{fn}} (11)

L_{F}=L_{O}−L_{Z}={l_{f1},l^{f2}, . . . ,l^{fm}} (12)

Defining ABR, MIBOR, and ALR

With the above definitions for B_{F} and L_{F} defined, calculation of the ABR, MIBOR, and ALR rates may be defined. These three rates are simple averages of the remaining reported rates:

$$\begin{matrix}ALR = \frac{{l}_{f 1} + {l}_{f 2} + … + {l}_{fm}}{\vert {L}_{F} \vert} & ( 13 ) \\ ABR = \frac{{b}_{{f}_{1}} + {b}_{{f}_{2}} + … + {b}_{fn}}{\vert {B}_{F} \vert} & ( 14 ) \\ MIBOR = \frac{ABR + ALR}{2} = \frac{{b}_{{f}_{1}} + … + {b}_{fn} + {l}_{{f}_{1}} + … + {f}_{fm}}{\vert {B}_{F} \vert + \vert {L}_{F} \vert} & ( 15 )\end{matrix}$$

Despite the fact that all panel members may be major financial institutions, not all members will necessarily be equally as credit-worthy. Because of this, the exchange may calculate and publish a credit adjustment table daily. The credit adjustment table may be a listing of each panel member with an adjustment rate listed for that firm, for each MIBOR duration. The rates from the credit adjustment table can be applied to actual trades to adjust the lending rate so that it reflects the credit-worthiness of the borrower.

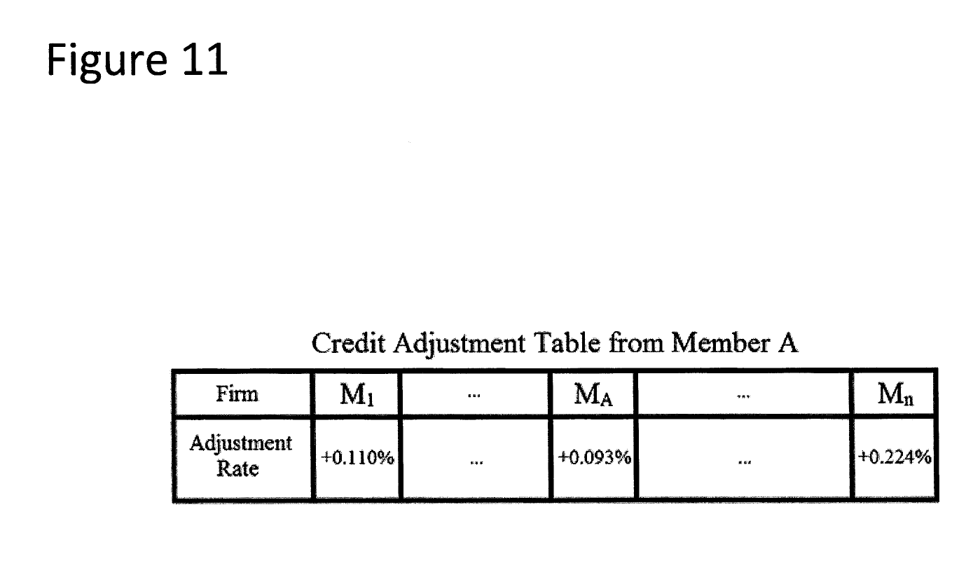

After calculations for the ABR, MIBOR, and ALR rates are performed, the adjustment rate may be added to the rate at which loans will be made to that member (see FIG. 2 and the “Exchange Governance Panel Agreement and MIBOR Publication” section). See below for a detailed description of how credit adjustment rates may be calculated. FIG. 11 illustrates a notional sample Credit Adjustment Table as submitted by one panel member. As can be seen in FIG. 11, the baseline may be set at an adjustment amount of +0.000% for the most credit worthy firm.

To discourage attempts at fixing the system by responding with borrowing rates or lending rates that attempt to manipulate any of the ABR, MIBOR, or ALR rates, a set of penalties may be set up against apparent manipulative rates.

If a panel member's or a panel participant's borrowing rate or lending rate crosses the MIBOR by more than the tolerance level, that panel member or panel participant may be penalized for the day. If a panel member or panel participant needs to lend, a penalty of the difference between MIBOR and its lending rate may be added to the rate at which it must lend. For example, assuming the rate it must lend at is called R₁ and its lending rate is l_{fx}, the rate it would be required to lend at would be:

R_{L}=MIBOR−|MIBOR−l_{fx}| (16)

Similarly, if a panel member whose borrowing rate crossed MIBOR by more than the tolerance level wished to borrow money on that day, that panel member could be required to pay the MIBOR rate plus the absolute value of the difference between the MIBOR rate and its crossing borrowing rate:

R_{B}=MIBOR+|MIBOR−b_{fx}| (17)

This means that the more severely that a panel member or panel participant transgresses, the higher the penalty. Thus, the final rate of any transaction could be:

R_{F}=MIBOR+(Adjustment rate of borrower)+(Penalty rate against borrower)−(Penalty rate against lender) (18)

Exchange Governance Panel Agreement and MIBOR Publication

All panel members and panel participants in the governance panel could be bound by an agreement whereby they must transact trades if certain conditions arise and that they must transact with a penalty or with a credit adjustment if certain conditions arise. Such an agreement would ensure that the MIBOR rate is a tradable rate thereby giving it relevance in any transaction which is indexed to LIBOR. These terms may be non-negotiable and it may be necessary for each member and participant to sign an exchange Governance Panel Agreement if they wish to participate on the governance panel.

After all submissions have been entered (at 11:10 AM GMT each day), the exchange may calculate ABR, MIBOR, ALR, and all credit adjustment values. At 11:30 AM GMT, the exchange may publish the ABR, MIBOR and ALR rates, the borrowing and lending rates from each panel member and panel participant, as well as the credit adjustment table. At 11:30:

If one panel member's borrowing rate is the same as another panel member's or panel participant's lending rate, those two stakeholders may be required to transact a trade at that rate for the duration and principal for which they submitted that rate.

If a panel member is required to transact a trade, and it is borrowing, and it has a credit adjustment rate (that is not +0.000%), that adjustment rate may be added to its borrowing rate for the transaction.

If a panel member enters a trade, and it is either borrowing or lending, and it has any additional penalty rate, it may be required to transact the trade at MIBOR plus or minus the penalty rate (as described in the Penalties section).

In the event that several panel members or panel participants are at the same lending rate and there is one member at the same rate but on the borrowing side, the lending panel member or panel participant who submitted its rate first may be required to enter the trade. The same may be required if there are several panel members on the borrowing side and one panel member or panel participant on the lending side.

In the event that several panel members or panel participants are at the same lending rate and there are several panel members at the same rate but on the borrowing side, the first panel member or panel participant on the lend side may be required to trade with the first panel member on the borrow side. If the first panel member on both sides is the same, then that panel member may trade with the second panel member or panel participant on the opposite side for the lending side and for the borrowing side.

These rules may be in effect so that MIBOR is a tradable rate and therefore a valid rate from which to index swap trades and other financial instruments.

After those panel members that are required to trade execute the trade, panel members may be able to submit a principal quantity on the lending side and panel members or panel participants may be able to submit a principal quantity on the borrowing side which will trade at the MIBOR rate plus the credit adjustment (if there is a panel member or panel participant on the other side with whom to trade).

Credit Adjustment Table

At present, two options are available for determining a credit adjustment table.

In the first method, the exchange may compose a daily adjustment table based upon the credit default spread of each panel member. This table would have an adjustment value for every panel member at every duration. Because credit default spreads do not typically extend to less than a three year duration, the exchange may apply a scaling factor to the 5 year credit default spread (the most liquid default spread).

Typically, if a 3-year, 5-year, and 10-year credit default spread were compared, one would find that the 3 year is the lowest basis point spread and that the 10-year is the highest basis point spread. However, there can be extreme financial situations during which the 3-year would be the highest and 10-year the lowest or even situations in which both the 3-year and 10-year are less than the 5-year spread. The exchange may provide different scaling for each of these three scenarios.

In the most common case, where the credit default spread increases with duration, the exchange may apply a positive exponential scaling curve to the 5-year credit default spread data for each individual member. By taking the scaling factor from various points on the exponential curve, the exchange may determine the appropriate adjustment rate for each member at each MIBOR duration. Then, the exchange may determine the most credit worthy member in each MIBOR duration and set their credit adjustment rate to +0.000%. The total credit adjustment of that most credit worthy panel member may then be subtracted from all other panel members' rates so that they are all benchmarked to the most credit worthy panel member.

More specifically, the exchange may gather credit default spread data from every available duration (3-year, 5-year, 10-year, etc.). The exchange may assume that the 5-year scaling factor is one and develop scaling factors for the known durations from 5-year scaling factor. Then the exchange will fit a logarithmic trend line to the scaled numbers to develop a scaling curve. The exchange may then estimate all MIBOR durations from the curve.

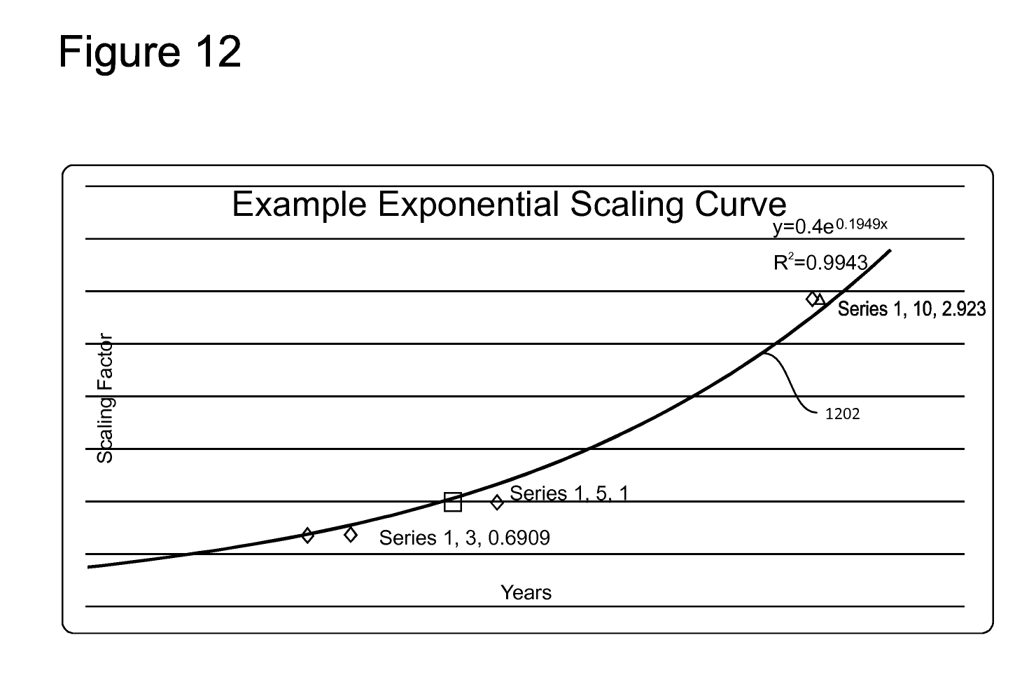

For example, assume Bank Q has a 3-year credit default spread of 152 bps (+1.52%), a 5-year credit default spread of 220 bps (+2.2%) and a 10-year credit default spread of 643 bps (+6.43%). Because the 5-year is assumed to have a scaling value of one, the 3-year has a scaling value of 0.6909 (152/220) and the 10-year has a scaling value of 2.923 (643/220). From this data, assume the scaling curve in FIG. 12 (this is purely an example curve and is not necessarily indicative of any market, any bank, or an exchange's actual estimation for this data), determined by the exchange, is appropriate, given the current market conditions and data.

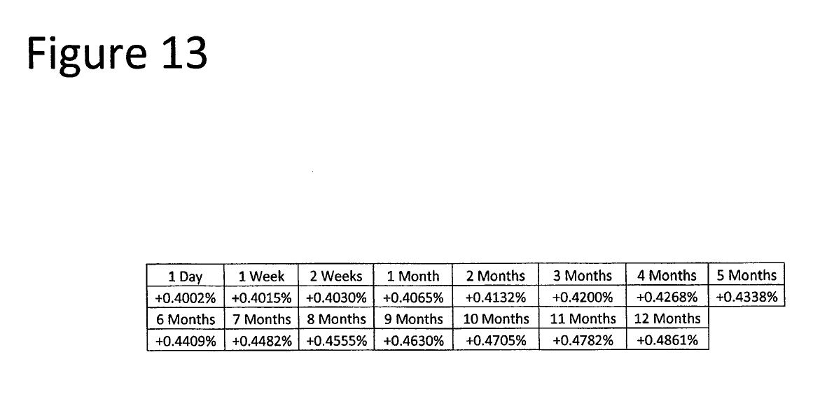

From this curve the exchange would produce the table in FIG. 13 for Bank Q. FIG. 13 is an exemplary adjustment table based upon the adjustment curve in FIG. 12. As noted in FIG. 12, this data is for example purposes only and is not indicative of any market, any bank, or of an actual estimation for the original data.

Now, assume that in the 3 month MIBOR term Bank X is the most credit worthy with an adjustment rate of +0.2560%. Bank X's adjustment rate is set to +0.000%. Bank Q's adjustment rate is benchmarked to Bank X by subtracting Bank X's adjustment rate leaving Bank Q with an adjustment rate of +0.1640% (0.4200−0.2560).

For the case in which the 3-year credit default spread is higher than the 10-year credit default spread, a negative exponential curve would be used to estimate the adjustment table values in the same way as described for case one.

For the final case in which, for instance, the 3-year and 10-year credit default spreads are both less than the 5-year spread, the exchange may apply a positive exponential curve to the data before, and including, the 5-year spread and develop a curve, as in Cases 1 and 2.

In the second method, the exchange may ask each panel member of the governance panel to submit a non-negative adjustment rate for each panel member including themselves in each of the broader implementation MIBOR durations (see FIG. 14 for an illustrative list of possible MIBOR values for a broader MIBOR implementation). If two panel members or a panel member and panel participant are required to trade or wish to trade through the open trading after the necessary trading is completed, the credit adjustment rate reported by each member may be compared. This leads to three cases:

The credit adjustment rate of the borrower, as listed by the lender, is less than the credit adjustment rate listed by borrower of themselves.

The credit adjustment rate of the borrower, as listed by the lender, and the credit adjustment rate listed by the borrower of themselves is the same.

The credit adjustment rate of the borrower, as listed by the lender, is greater than the credit adjustment rate listed by the borrower of themselves.

In Case 1, the two panel members or the panel member and participant trade at the MIBOR rate plus the credit adjustment rate listed by the lender (the lower credit adjustment rate).

In Case 2, the two panel members or the panel member and panel participant trade at the MIBOR rate plus the credit adjustment rate listed by both the lender and borrower.

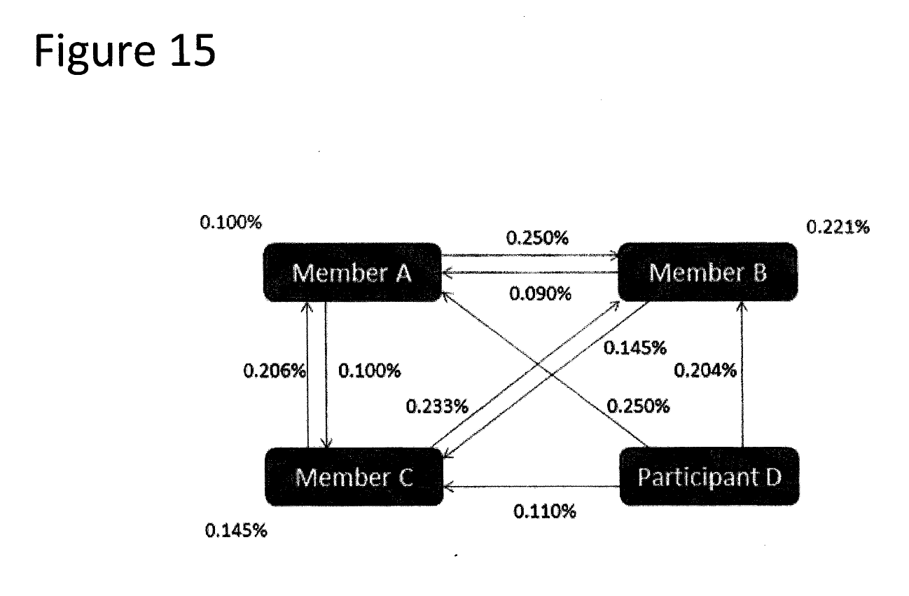

In Case 3, rather than trying to compromise between the two trading parties, the exchange may employ a graph algorithm that will match the parties with other parties with whom they can trade. FIG. 15 shows an exemplary graph of three panel members and one panel participant with credit adjustments for other panel members shown. Each panel member and panel participant will be modeled as a node of a directed graph.

The algorithm attempts to match panel participants and panel members who can trade in order to create a path between the lender and the borrower. For instance, taking the example in FIG. 13, assume that Panel Participant D must lend to Panel Member A and that the principal is $100 million USD for 3 months. However, Panel Participant D requires a credit adjustment of +0.250 in order to trade with Panel Member A yet Panel Member A considers their own credit adjustment rate to be +0.100%. In order to complete the trade, the algorithm would look at all other members and compare their self-adjudicated adjustment rates with Panel Participant D's credit adjustment rate for that member. Panel Participant D would be willing to lend to Panel Member B or Panel Member C because Panel Participant D's adjustment rate is lower than the self-adjudicated adjustment rates in both cases. Then the algorithm compares Panel Member C's and Panel Member B's adjustment rates for Panel Member A against Panel Member A's self-adjudicated adjustment rate. The algorithm finds that Panel Member B would be willing to trade with Panel Member A and that Panel Member C would not be willing to trade with Panel Member A. The lender and borrower have now been connected; Panel Participant D lends $100 million USD to Panel Member B at MIBOR+0.204% for three months and Panel Member B lends $100 million USD to Panel Member A at MIBOR+0.090% for three months.

In the event that none of these cases are applicable, particularly, in the case that neither the borrower nor lender agree on the adjustment rate and no other members or participants meet the criteria of the graph algorithm, the two parties will trade at the MIBOR rate plus the average of the credit adjustment rates listed by the two parties for the borrower.

Credit Adjustment Algorithm

It is assumed that if there is a complete path from borrower to lender that the same path can be found if searching from lender to borrower. To simplify the search, by excluding participants except at the root level of the search, because panel participants cannot borrow, the search will start with the lender and attempt to find a path to the borrower.

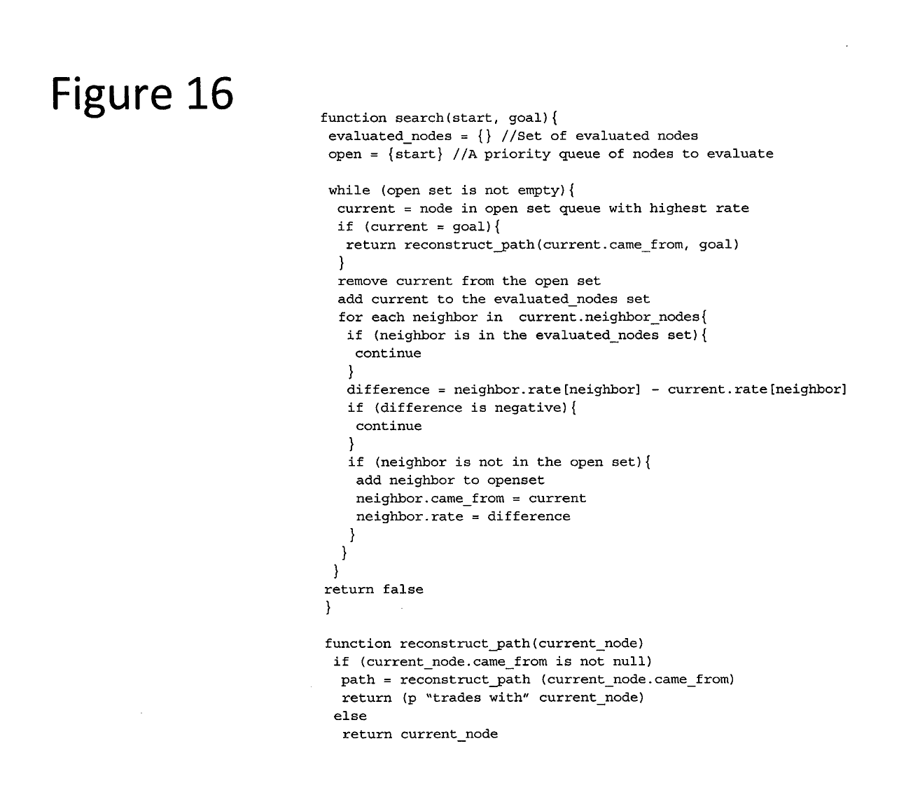

At present, the graph search algorithm that best suits the needs of this application is a modified search described in the pseudo code shown in FIG. 16.

Process Implementation

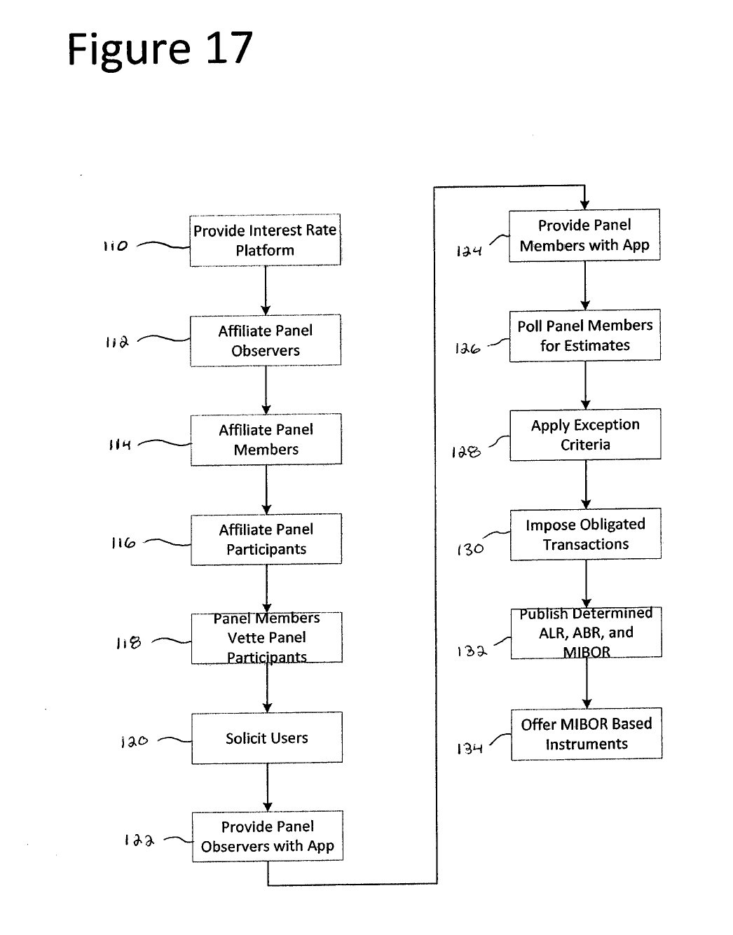

As can be seen from the above, and as shown in FIG. 17, the governance panel, including the interest rate platform, may be embedded in a process for calculating marketable MIBOR, ALR and ABR values upon which financial instruments can be based. The process may be founded on providing an interest rate calculation platform (110), which is capable of performing communications functions with respect to panel members, panel observers, and users of the calculated MIBOR, ALR, and ABR rates. The users may be subscribers to a service for informing those users of the calculated values. The platform may also implement the calculated MIBOR, ALR, and ABR values as a central parameter to offered financial instruments, such as wherein the operator of the interest rate platform functions as a counter-party for offered interest rate swaps.

With respect to offered financial instruments, the operator may offer to be a counterparty to tradable swaps using the calculated MIBOR as the variable interest rate position for the variable side of the swap, as well as offer to be a counterparty to tradable swaps using the calculated MIBOR, in which the operator offers to pay the fixed interest side of an interest rate swap in which the buyer agrees to pay the variable interest rate side.

From the above, the interest rate platform may additionally be provided with functionality for calculating not only the MIBOR, ALR, and ABR themselves, but also providing the functionality which tests information on interest rates received from panel members in accordance with exception rules as established by the panel observers.

A group of panel observers (112) may be solicited for affiliation with the governance panel. The panel observers may preferably be entities that do not have a direct interest in the value of the calculated MIBOR, ALR and ABR, such that the panel observers may act as disinterested observers of the process, providing transparency to the method of calculation imposed, as well as the exception rules implemented. Further, as the present process may impose disciplinary actions, such as obligated lending when estimated rates are outside of established parameters, the disinterest of the panel observers provides credibility to the determined values and obligated actions.

Next, a group of panel members (114) may be solicited for affiliation with the governance panel. The panel members will typically be financial institutions which actually transact loans based on inter-bank transfers, such that the panel members will have an interest in the accurate determination of MIBOR, ALR, and ABR rates. It is known that the panel members may have biases in their estimated interest rates; however, the present method is designed to avoid inclusion of any such biases in the final calculated values.

The panel members may solicit panel participants (116) from their clients to be further involved in the determination process. Typically, the panel participants will receive access to determined MIBOR, ALR, and ABR values without needing to provide further consideration to the operator of the governance panel.

Panel members would be required to verify the creditworthiness of prospective panel participants, such that in the event that transactions were to be obligated, it would have been pre-determined that the panel participants were able to engage in the necessary transactions (118).

A group of users may next be solicited (120), such that the determined MIBOR, ALR, and ABR values will be implemented within the financial markets with a return to the operator of the governance panel.

The panel observers may be provided with a computer application, connected to the interest rate platform through a network, for both observing the determination process, and being polled with respect to exception thresholds to be imposed (122).

The panel members may be provided with a computer application, connected to the interest rate platform through a network, to allow the panel members to report estimated lending rates and borrowing rates, as well as estimated lending rates received from panel participants (124).

At a pre-determined time, the interest rate platform would poll the panel members to determine the estimated ALR and ABR for a given time period, usually the time at which the poll takes place, for a given monetary amount and loan duration (126).

The interest rate platform would receive the estimated lending rates and borrowing rates from the panel members, and if any panel participants reported to their panel members, the estimated lending rates of the panel participants.

The interest rate platform may then apply threshold criteria to the reported estimated interest rates, to identify exceptions to the rules imposed by the interest rate platform (128).

From the filtered estimated interest rates, the interest rate platform may calculate the ALR, ABR, and MIBOR values.

The interest rate platform may then analyze the creditworthiness of the reporting panel participants, and generate an adjustment table to adjust the interest rates at which loans would be transacted with the particular panel participants based on the creditworthiness of the particular panel participants. Calculation of such interest rate adjustments is discussed above.

The interest rate platform may then impose any transactions indicated by the reported estimates of the panel participants (130). The decision to impose such an obligated transaction may be automatically implemented, or may be screened by a poll of the panel observers.

The generated ALR, ABR, and MIBOR rates may then be published to users of the data via the network connecting the users to the interest rate platform (132).

Financial Instruments

From the above, the availability of a credible, transparent, and tradable MIBOR value allows both the operator of the interest rate platform, as well as user's receiving the determined values, to offer financial instruments based on the determined values (134). For example, the operator of the interest rate platform could offer to take one side of an interest rate swap, with the variable leg of the swap set by the determined interest rates, with or without a premium over the determined rate. Periodic payments on the variable interest rate side of the swap would be determined by the determined rates as determined on successive intervals, i.e., daily, weekly, or monthly. Payments due on the variable leg of the swap could be published by the operator, such that parties holding the fixed interest side of the swap would be able to quickly identify revenue streams associated with the position, through subscription to the interest rate platform output.

Accordingly, the system and method of the present disclosure, as well as resultant financial products, addresses many of the pressing issues with the current LIBOR system.

The proposed MIBOR system would deliver a rate through a transparent and independent process run by a CFTC-regulated exchange using a governance process open to large dealers, regulators, and buy-side participants. The process would also be transparent to regulatory bodies and provide grounds for disciplinary action in order to remove any incentive for members or participants to attempt to manipulate ABR, MIBOR or ALR. This method eliminates both the incentive and the ability for banks to manipulate ABR, MIBOR and ALR; however, the process preserves a structure similar to the current system in order that the trillions of dollars of trades already resting on the LIBOR would remain stable. Thus, this process is more robust than the one presently in place as it is based on more data points and those data points are more reliable due to the vetting process that each rate goes through.

The present invention may be embodied in other specific forms without departing from the spirit or essential attributes of the invention. Accordingly, reference should be made to the appended claims, rather than the foregoing specification, as indicating the scope of the invention.

What is claimed is:

1. A method for decreasing potential bias of an estimated inter-bank offered interest rate, the method comprising:
Identifying a plurality of panel members willing to timely provide estimated interest rates for borrowing a certain sum of money and for lending a certain sum of money;
Identifying a panel observer, said panel observer serving as a disinterested party regarding analysis of submitted borrowing rate and lending rate estimates;
Providing an interest rate analysis platform for receiving estimated borrowing and lending rates from said plurality of panel members;
Providing panel members access to a computer application to allow said panel members to report estimated lending rates and borrowing rates;
Receiving at the interest rate analysis platform estimated lending rates and borrowing rates via a computer network;
Determining on said interest rate analysis platform an average lending rate based on estimated lending rates provided by said plurality of panel members;
Determining on said interest rate analysis platform an average borrowing rate based on estimated borrowing rates provided by said plurality of members;
Determining from said average lending rate and said average borrowing rate a mean inter-bank offered interest rate;
Disseminating via an electronic network said determined average borrowing rate, said determined average lending rate, and said determined mean inter-bank offered rate to at least one recipient.

2. A method according to claim 1, further comprising:
Identifying from said plurality of panel members at least one potential panel participant, said at least one panel participant willing to timely provide information associated with an estimated lending rate for lending a certain sum of money.

3. A method according to claim 2, further comprising:
Requiring panel members to vette the creditworthiness of panel participants associated with said panel member.

4. A method according to claim 2, further comprising;
Determining an interest rate adjustment for each panel participant, said interest rate adjustment useable for adjusting borrowing or lending rates associated with said panel participant based on the creditworthiness of said panel participant.

5. A method according to claim 1, further comprising;
Applying exception criteria to said reported estimated lending rates and said estimated borrowing rates to identify estimates which may reflect a bias before determining the average lending rate and the average borrowing rate.

6. A method according to claim 5, wherein the exception criteria are determined by polling the panel observers.

7. A method according to claim 1, further comprising:
Imposing a financial transaction on one or more panel participants as a result of an estimated lending rate provided by said panel participant exceeding exception criteria.

8. A method according to claim 1, further comprising:
Offering to enter into a financial contract to pay an amount of interest based on a variable rate determined on a notional amount for a predefined duration in exchange for receiving a an amount of interest based on a fixed rate on a notional amount for a predefined duration.

9. A method according to claim 1, further comprising:
Offering to enter into a financial contract to pay an amount of interest based on a fixed rate on a notional amount for a predefined duration in exchange for receiving an amount of interest based on a variable amount of interest on a notional amount for a predefined duration.

10. An interest rate swap financial instrument, said financial instrument characterized by an obligation to pay to a counter-party a sum of money based on a variable interest rate on a notional amount of said financial instrument and a tenure of said financial instrument, wherein said variable interest rate is determined by a method comprising:
Identifying a plurality of panel members willing to timely provide estimated interest rates for borrowing a certain sum of money and for lending a certain sum of money;
Identifying a panel observer, said panel observer serving as a disinterested party regarding analysis of submitted borrowing rate and lending rate estimates;
Providing an interest rate analysis platform for receiving estimated borrowing and lending rates from said plurality of panel members;
Providing panel members access to a computer application to allow said panel members to report estimated lending rates and borrowing rates;
Receiving at the interest rate analysis platform estimated lending rates and borrowing rates from said panel members via a computer network;
Determining on said interest rate analysis platform an average lending rate based on estimated lending rates provided by said plurality of panel members;
Determining on said interest rate analysis platform an average borrowing rate based on estimated borrowing rates provided by said plurality of members; and
Determining from said average lending rate and said average borrowing rate a mean inter-bank offered interest rate.

11. A method according to claim 10, wherein the variable interest rate is determined by a method further comprising:
Identifying from said plurality of panel members at least one potential panel participant, said at least one panel participant willing to timely provide information associated with an estimated lending rate for lending a certain sum of money.

12. A method according to claim 11, wherein the variable interest rate is determined by a method further comprising:
Requiring panel members to vette the creditworthiness of panel participants associated with said panel member.

13. A method according to claim 11, wherein the variable interest rate is determined by a method further comprising:
Determining an interest rate adjustment for each panel participant, said interest rate adjustment useable for adjusting borrowing or lending rates associated with said panel participant based on the creditworthiness of said panel participant.

14. A method according to claim 10, wherein the variable interest rate is determined by a method further comprising:
Applying exception criteria to said reported estimated lending rates and said estimated borrowing rates to identify estimates which may reflect a bias before determining the average lending rate and the average borrowing rate.

15. A method according to claim 14, the exception criteria are determined by polling the panel observers.

16. A system for determining a mean inter-bank offered rate, the system comprising:
An interest rate platform, said platform being communicably connected to at least one computer network;
A plurality of panel members, said panel members for reporting estimated lending rates and estimated borrowing rates to said interest rate platform through said computer network;
At least one panel observer, said panel observer for observing determinations of average lending rates, average borrowing rates, and a mean inter-bank offered rate, and identifying potentially biased estimated borrowing rates and lending rates reported by said panel members;
Wherein said interest rate platform receives estimated lending rates and estimated borrowing rates from said panel members, applies exception criteria to said reported estimated lending rates and said estimated borrowing rates, and determines an average lending rate, and average borrowing rate, and a mean inter-bank offered rate from said estimated lending rates and estimated borrowing rates.

17. A system in accordance with claim 16, further comprising:
At least one panel participant, said panel participant for reporting estimated lending rates to said interest rate platform via an affiliated panel member through said computer network.

18. A system in accordance with claim 17, wherein said interest rate platform further comprises a reporting module which publishes to one or more users the determined average lending rate, average borrowing rate, and mean inter-bank offered rate via said computer network to one or more users who have subscribed to receive said average lending rate, average borrowing rate, and mean inter-bank offered rate.

19. A system in accordance with claim 17, wherein said interest rate platform further comprises a panel participant credit adjustment module, wherein said credit adjustment module calculates client rate adjustments for each panel participant dependent on the creditworthiness of the panel participant.

20. A system in accordance with claim 16, wherein said exception criteria comprises a maximum spread between an estimated lending rate and an estimated borrowing rate reported by a panel member for said estimated lending rate and said estimated borrowing rate to be considered when calculating said average borrowing rate and said average lending rate.
